(19) United States
(12) Patent Application Publication
(10) Pub. No.: US 2025/0365472 A1
(43) Pub. Date: Nov. 27, 2025

(54) METHODS AND APPARATUS TO DETERMINE ADDITIVE REACH ADJUSTMENT FACTORS FOR AUDIENCE MEASUREMENT

(71) Applicant: The Nielsen Company (US), LLC, New York, NY (US)

(72) Inventors: Joshua T. Deragon, Pittsburgh, PA (US); David J. Kurzynski, Elgin, IL (US); Denis Voytenko, Oldsmar, FL (US); Horalia Armas, Palatine, IL (US); William DeShong, Virginia Beach, VA (US); Brett Gebhardt, Los Angeles, CA (US)

(21) Appl. No.: 19/250,872

(22) Filed: Jun. 26, 2025

Related U.S. Application Data
(63) Continuation of application No. 17/978,054, filed on Oct. 31, 2022, now Pat. No. 12,348,817.
(60) Provisional application No. 63/349,471, filed on Jun. 6, 2022.

(51) Int. Cl. H04N 21/458; H04N 21/466

(52) U.S. Cl. CPC H04N 21/4586; H04N 21/4667

(57) ABSTRACT

Methods, apparatus, systems, and articles of manufacture to determine an additive reach adjustment factor for audience measurement are disclosed.

### CROSS-REFERENCE TO RELATED APPLICATIONS

This application is a continuation of U.S. patent application Ser. No. 17/978,054 filed on Oct. 31, 2022, now issued as U.S. Pat. No. 12,348,817, which claims priority to U.S. Provisional Patent Application No. 63/349,471 filed on Jun. 6, 2022, each of which is hereby incorporated by reference in its entirety.

### FIELD OF THE DISCLOSURE

This disclosure relates generally to reach and, more particularly, to determining additive reach adjustment factors for audience measurement.

### BACKGROUND

In recent years, audiences of digital media have extensive options of content (e.g., shows, films, news, online videos, etc.) to access using numerous sources (e.g., cable, over the air (OTA), smart televisions (TVs), digital streaming devices, or alternate delivery systems (ADS), such as satellite). Tuning data (e.g., minutes viewed, content title, genre, daypart, demographic, device type, etc.) is collected to gather insights on audiences viewing the content and can include panel data and/or Big Data. Panel data is monitored and measured (e.g., via surveys, metering devices, sensors, background applications, etc.) for a panel of households and/or members to better understand characteristics of audiences that view particular stations or over the top (OTT) streaming services. The panel includes a subset of members with varying demographics to represent the larger population. The panel data can inform which panel members of the panel household are using a presentation device at a given time. Big Data is collected in the form of return path data (RPD) and automated content recognition (ACR) data to complement the panel data. Big Data monitors a much larger audience than the panel and includes information related to specific content viewed, content metadata, and engagement (e.g., number of viewing minutes) of the panel member(s). RPD can be gathered via a set-top box (e.g., a cable or satellite box), and ACR data can be gathered via ACR devices/technology integrated with or connected to Smart TVs (e.g., Vizio®) and/or hardware digital media devices (e.g., Roku®).

### BRIEF DESCRIPTION OF THE DRAWINGS

FIG. 1 is a block diagram of an example computing device to determine an additive reach adjustment factor.

FIGS. 2A-2F illustrate example tables depicting steps taken by the computing device of FIG. 1 to calculate the additive reach adjustment factor.

FIG. 3 is a flowchart representative of example machine readable instructions and/or example operations that may be executed by example processor circuitry to implement the computing device of FIG. 1.

FIG. 4 is a block diagram of an example processing platform including processor circuitry structured to execute the example machine readable instructions and/or the example operations of FIG. 3 to implement the computing device of FIG. 1.

FIG. 5 is a block diagram of an example implementation of the processor circuitry of FIG. 4.

FIG. 6 is a block diagram of another example implementation of the processor circuitry of FIG. 4.

FIG. 7 is a block diagram of an example software distribution platform (e.g., one or more servers) to distribute software (e.g., software corresponding to the example machine readable instructions of FIG. 3) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description. As used herein “substantially real time” refers to occurrence in a near instantaneous manner recognizing there may be real world delays for computing time, transmission, etc. Thus, unless otherwise specified, “substantially real time” refers to real time+/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

### DETAILED DESCRIPTION

An issue occurs when some stations have missing tuning. For example, third party media measurement companies may receive tuning from ACR devices, and ACR devices identify what the tuning information is. Some stations are unidentified by the ACR devices due to the ACR devices not recognizing the station. As such, the tuning of the stations goes unmeasured. In some examples, missing tuning can create instances where reach is lower than it should be due to a number of people that are missing tuning data. In some examples, instances where unmeasured stations impact the reach are instances where all of a person's tuning to a marketing campaign is missing. In some examples, there are instances where only some, but not all, of a person's tuning to a campaign is missing. In such an example, the person is still included in the reach.

In some examples, each station for each daypart is given a station factor (e.g., a value between 1 and 1.5) to account for the missing tuning. For example, additional weight is given to stations, using the station factors, during certain time periods to account for the missing tuning data. In some examples, the station factors are determined based on panel data. Given that there is usually some missing tuning, the actual reach is often larger than what it is calculated to be, so the station factors can be used in combination with tuning information of the sample to adjust the calculated reach to account for this missing tuning data. However, these station factors are estimates and may not completely represent the amount of unmeasured tuning for a given station and daypart.

Examples disclosed herein determine an additive reach adjustment that can be added to a calculated reach from a given data set (e.g., from an ACR device). For example, examples disclosed herein determine whether or not someone viewed and/or was exposed to a media marketing campaign during a time period.

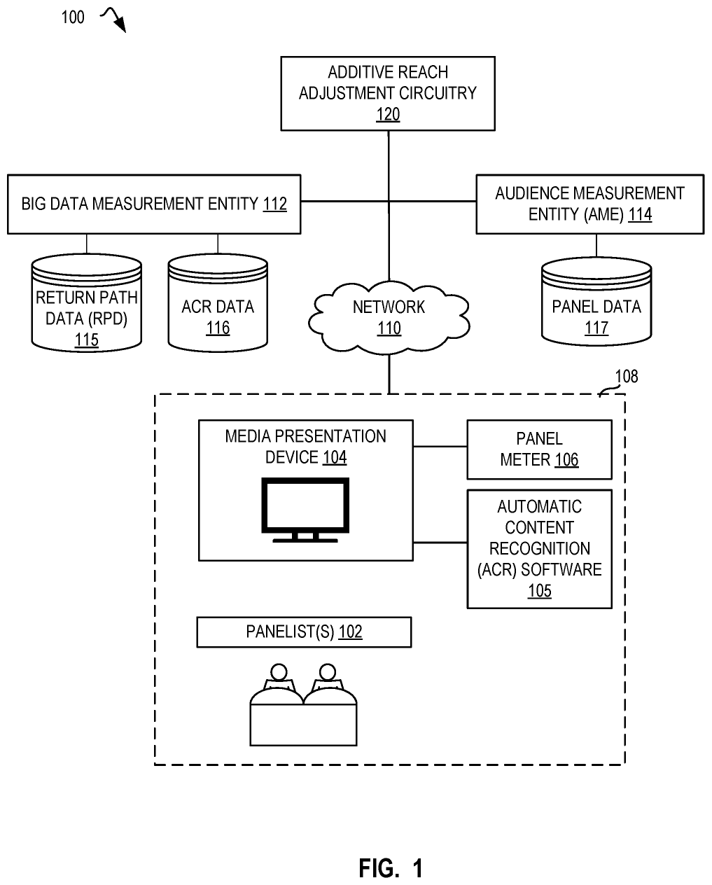

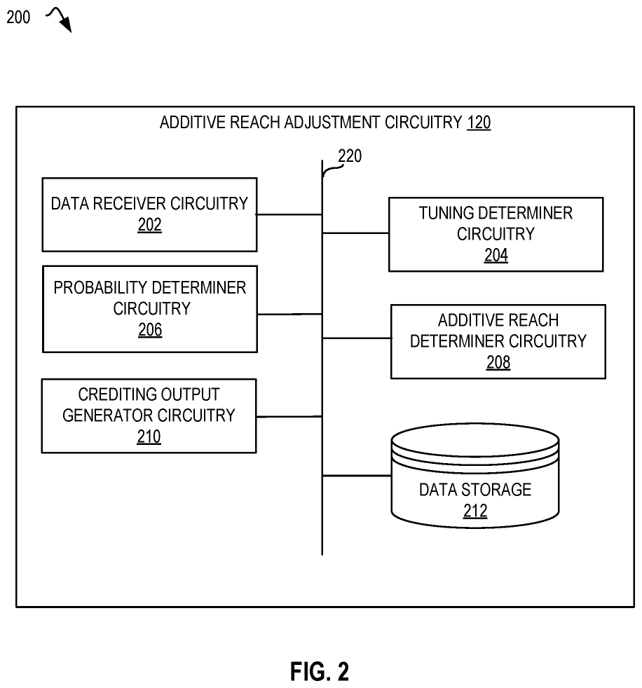

FIG. 1 is a block diagram of an example computing device 100 to do determine an additive reach adjustment factor for a station and daypart. The computing device 100 of FIG. 1 may be instantiated (e.g., creating an instance of, bring into being for any length of time, materialize, implement, etc.) by processor circuitry such as a central processing unit executing instructions. Additionally or alternatively, the computing device 100 of FIG. 1 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 2 may, thus, be instantiated at the same or different times. Some or all of the circuitry may be instantiated, for example, in one or more threads executing concurrently on hardware and/or in series on hardware. Moreover, in some examples, some or all of the circuitry of FIG. 2 may be implemented by microprocessor circuitry executing instructions to implement one or more virtual machines and/or containers.

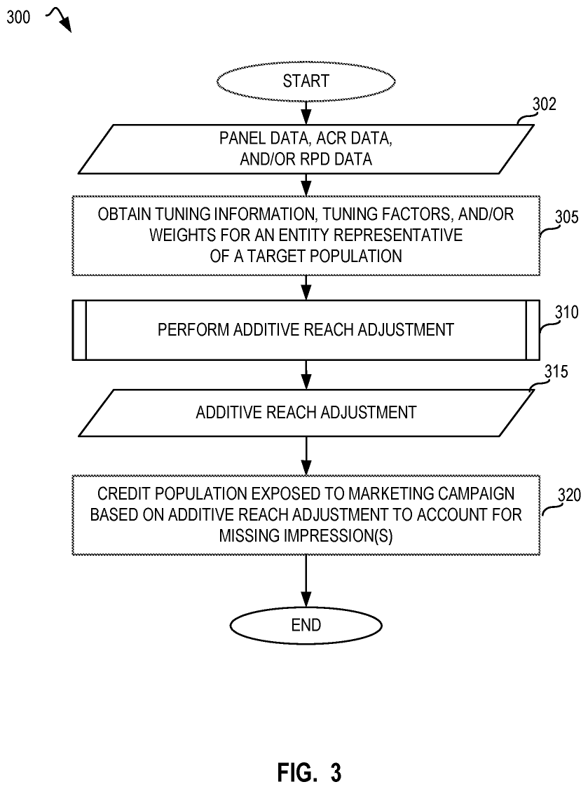

The computing device 100 of FIG. 1 includes example interface circuitry 102, example tuning determination circuitry 104, example probability determination circuitry 106, and example additive reach determination circuitry 108. In some examples, the interface circuitry 102 is instantiated by processor circuitry executing interface instructions and/or configured to perform operations such as those represented by the flowchart of FIG. 3. In some examples, the tuning determination circuitry 104 is instantiated by processor circuitry executing tuning determination instructions and/or configured to perform operations such as those represented by the flowchart of FIG. 3. In some examples, the probability determination circuitry 106 is instantiated by processor circuitry executing probability determination instructions and/or configured to perform operations such as those represented by the flowchart of FIG. 3. In some examples, the additive reach determination circuitry 108 is instantiated by processor circuitry executing additive reach determination instructions and/or configured to perform operations such as those represented by the flowchart of FIG. 3.

In FIG. 1, the interface circuitry 102 is to obtain tuning information. In some examples, tuning information includes an entity corresponding to the tuning information, such as a person or a household, a period of time corresponding to when the tuning information was collected, and station information corresponding to a specific channel, show, television program, etc., that the entity may have been exposed to. In some examples, the tuning information also includes measurement data corresponding to whether the entity was exposed to and/or viewed a station during a particular period of time. In some examples, the interface circuitry 102 obtains a weight for an entity. For example, the interface circuitry 102 obtains a weight value indicative of how many people in a population that the entity represents. In some examples, the interface circuitry 102 obtains a tuning factor, such as the factor described above, for the station that is being measured. As used herein, a “station factor” and a “tuning factor” are used interchangeably.

In FIG. 1, the tuning determination circuitry 104 is to determine percentages of the target population who tuned to a desired marketing campaign and percentages of tuning that was unmeasured for the desired marketing campaign. In some examples, the desired marketing campaign corresponds to a particular station.

In FIG. 1, the probability determination circuitry 106 determines a first probability that a population was exposed to (e.g., tuned to) the marketing campaign for a particular day/daypart but the tuning was unmeasured. In some examples, the first probability that the population was exposed to the marketing campaign is determined by multiplying a percentage of the population who tuned to the desired marketing campaign on that particular day/daypart by the percentage corresponding to tuning that was unmeasured for the desired marketing campaign. The example probability determination circuitry 106 determines a second probability that the population was not exposed to (e.g., did not tune to) the marketing campaign on a particular day/daypart or the tuning was unmeasured. For example, the probability determination circuitry 106 determines the second probability by subtracting the percentage of the population who tuned to a desired marketing campaign from one, and then adding that value to the corresponding first probability. The probability determination circuitry 106 determines a compound probability that an entity was not exposed to (e.g., did not tune to) the marketing campaign or the tuning was unmeasured across all days, dayparts, and stations. The probability determination circuitry 106 also determines a separate no-tuning probability corresponding to the probability that the population was not exposed to (e.g., did not tune to) the marketing campaign across all days, day parts, and stations

In FIG. 1, the example additive reach determination circuitry 108 determines an additive reach adjustment based on the difference between the compound probability and the no-tuning probability. The additive reach adjustment is a probability that an entity was exposed to the marketing campaign over a selected time period but was not credited for the impression(s).

FIGS. 2A-2F illustrate example tables depicting steps taken to calculate the additive reach adjustment factor. FIG. 2A illustrates example tables 1-3 depicting example unmeasured station impact scenarios. In FIG. 2A, table 1 depicts true tuning data. True tuning data corresponds to what a person has actually watched. For example, on a particular day, one person watched stationed A and not station B. However, due to missing tuning data, the Big Data, shown in table 3, falsely shows that the person has not watched stations A nor B. So we try to determine how often this non-measurement happens, and use that probability as the additive reach.

FIG. 2B illustrates example tables 4-5 depicting how the example tuning determination circuitry 104 determines (i) the percent of a population that tuned to a desired marketing campaign for a given day, daypart, and station based on the tuning factor and weight for the entity (e.g., by multiplying each person's weight by the station factory if that person tuned to the station during the daypart and then summing over the persons) and (ii) the percent of tuning that went missing (e.g., was unmeasured) for each station, day, and day part (e.g., by subtracting the inverse of the tuning factor from 1).

FIG. 2C illustrates example tables 6-8 depicting how the example probability determination circuitry 106 determines a first probability that a population tuned to a desired marketing campaign and the tuning data was unmeasured (e.g., by multiplying the entries of table 6 by the corresponding entries of table 7 to yield the entries of table 8).

FIG. 2D illustrates example tables 6, 9, and 10 depicting how the example tuning determination circuitry 104 determines, based on the first probability, a second probability that the population did not tune to the desired marketing campaign or the tuning was unmeasured (e.g., by subtracting the entries of table 6 from the value 1 to yield the entries of table 9, and then adding the entries of table 9 to the corresponding entries of table 8 to yield the entries of table 10).

FIG. 2E illustrates tables 11-14 depicting how the example probability determination circuitry 106 determines a compound probability that the population was not exposed to (e.g., did not tune to) a marketing campaign or the tuning was unmeasured across all days, day parts, and stations (e.g., by multiplying the respective entries of table 10 for a given day and daypart to yield the rightmost column of table 11, and then summing the rightmost column of table 11 to yield the compound probability), and a separate no-tuning probability corresponding to the probability that the population was not exposed to (e.g., did not tune to) the marketing campaign across all days, day parts, and stations (by multiplying the respective entries of table 9 for a given day and daypart to yield the rightmost column of table 13, and then summing the rightmost column of table 13 to yield the no-tuning probability).

FIG. 2F illustrates tables 15-16 depicting how the example additive reach determination circuitry 108 determines the additive reach adjustment factor based on the different between the compound and no-tuning probabilities.

While an example manner of implementing the computing device 100 of FIG. 1 is illustrated in FIG. 1, one or more of the elements, processes, and/or devices illustrated in FIG. 1 may be combined, divided, re-arranged, omitted, eliminated, and/or implemented in any other way. Further, the example interface circuitry 102, the example tuning determination circuitry 104, the example probability determination circuitry 106, the example additive reach determination circuitry 108, and/or, more generally, the example computing device 100 of FIG. 1, may be implemented by hardware alone or by hardware in combination with software and/or firmware. Thus, for example, any of the example interface circuitry 102, the example tuning determination circuitry 104, the example probability determination circuitry 106, the example additive reach determination circuitry 108, and/or, more generally, the example computing device 100, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example computing device 100 of FIG. 1 may include one or more elements, processes, and/or devices in addition to, or instead of, those illustrated in FIG. 1, and/or may include more than one of any or all of the illustrated elements, processes and devices.

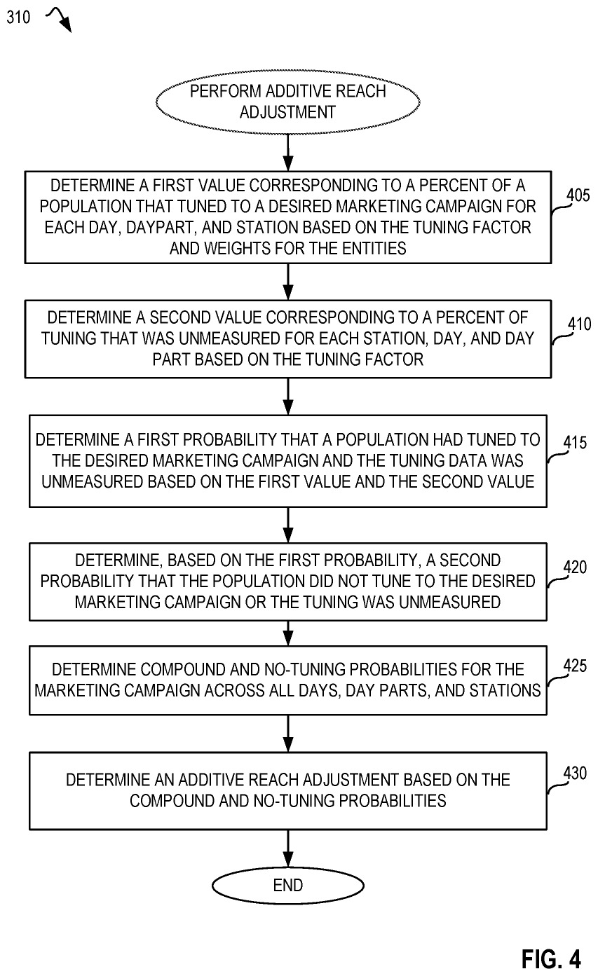

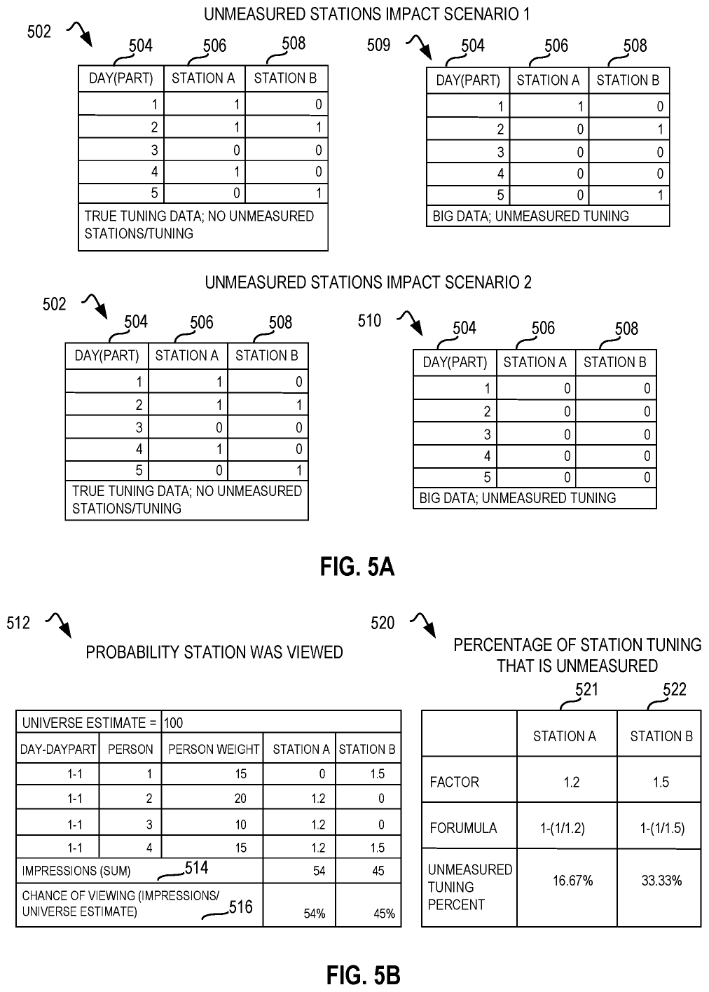

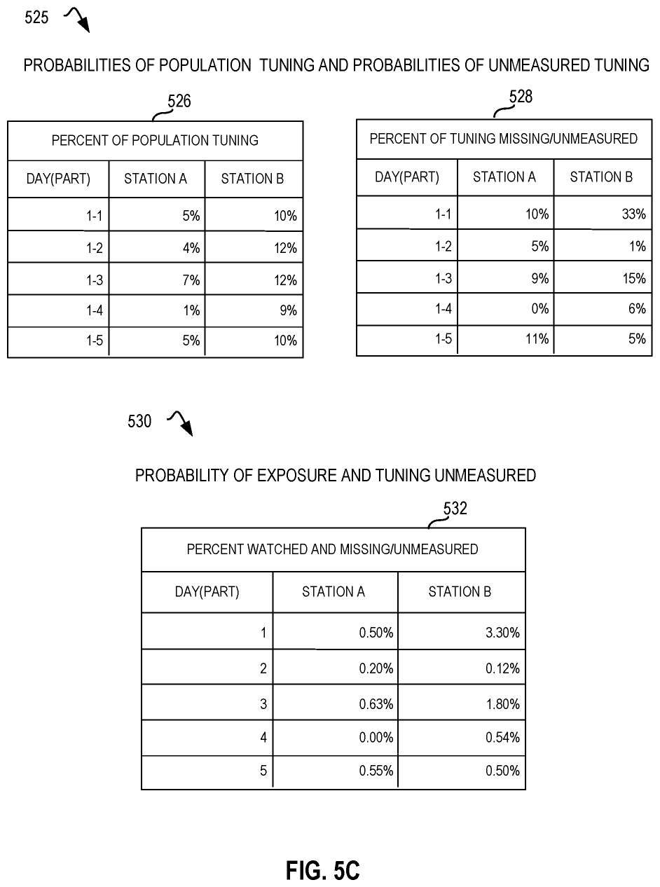

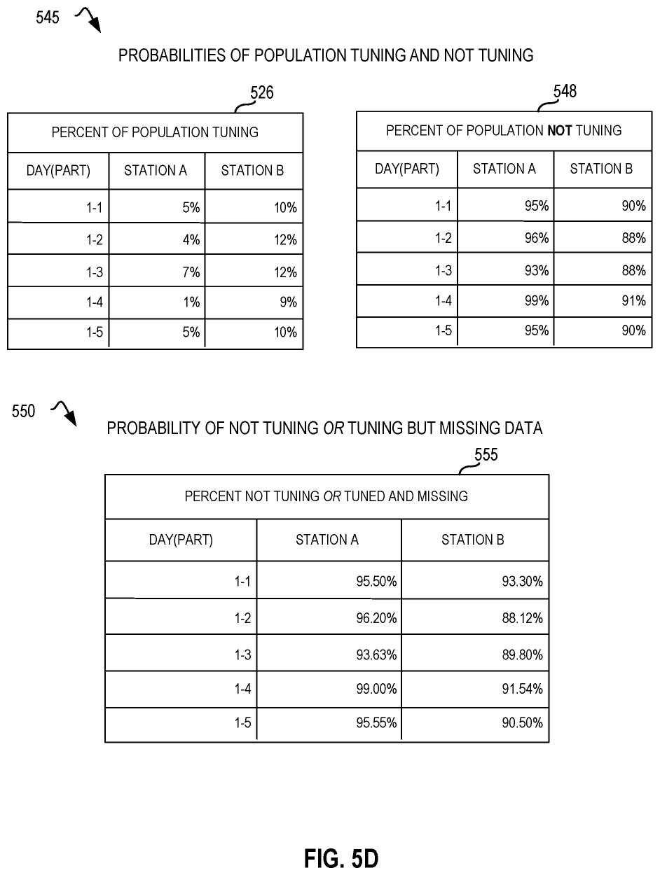

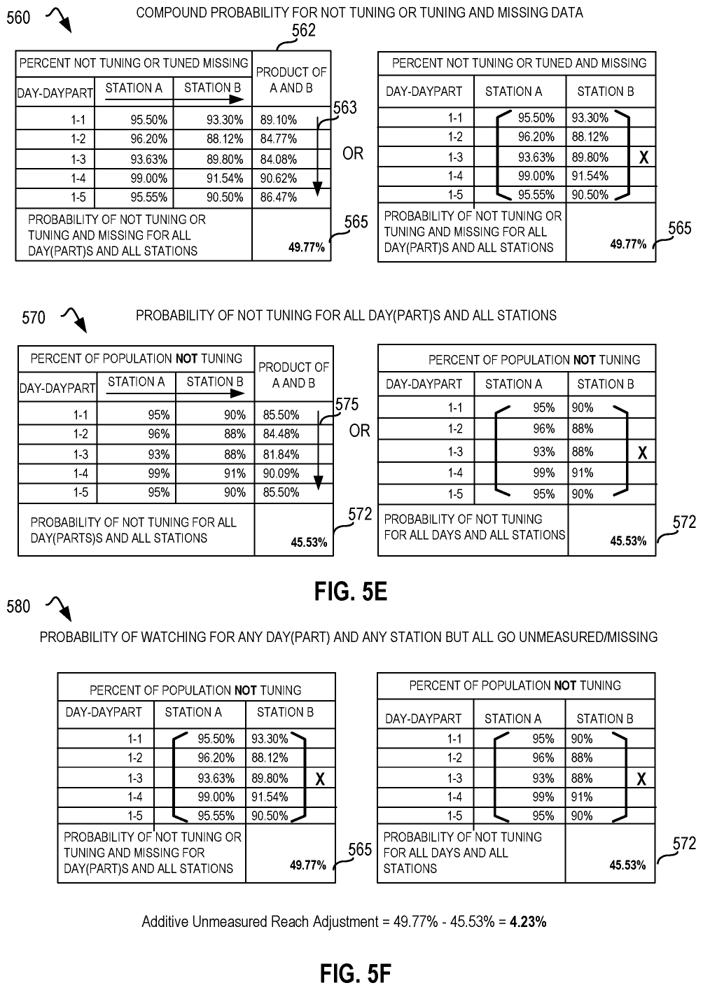

A flowchart representative of example machine readable instructions, which may be executed to configure processor circuitry to implement the computing device 100 of FIG. 1, is shown in FIG. 3. The machine readable instructions may be one or more executable programs or portion(s) of an executable program for execution by processor circuitry, such as the processor circuitry 412 shown in the example processor platform 400 discussed below in connection with FIG. 4 and/or the example processor circuitry discussed below in connection with FIGS. 5 and/or 6. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowchart illustrated in FIG. 3, many other methods of implementing the example computing device 100 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. [figure nos.] may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 3 is a flowchart representative of example machine readable instructions and/or example operations 300 that may be executed and/or instantiated by processor circuitry to determine an additive reach adjustment factor. The machine readable instructions and/or the operations 300 of FIG. 3 begin at block 302, at which the interface circuitry 102 obtains tuning information, tuning factors, and weights for entities representative a target population.

The example tuning determination circuitry 104 determines a first value corresponding to a percent of a population that tuned to a desired marketing campaign for each day, daypart, and station based on the tuning factors and the weights for the entities (block 304). For example, the tuning determination circuitry 104 determines the first value as shown in table 4 of FIG. 2B.

The example tuning determination circuitry 104 determines a second value corresponding to a percent of tuning that was unmeasured for each station, day, and daypart based on the tuning factors (block 306). For example, the tuning determination circuitry 104 determines the second value as shown in table 5 of FIG. 2B.

The example probability determination circuitry 106 determines a first probability that a population had tuned to the desired marketing campaign and the tuning data was unmeasured (block 308). For example, the probability determination circuitry 106 determines the first probability as shown in tables 6-8 of FIG. 2C.

The example probability determination circuitry 106 determines, based on the first probability, a second probability that the population did not tune to the desired marketing campaign or the tuning was unmeasured (block 310). For example, the probability determination circuitry 106 determines the second probability as shown in tables 6, 9, and 10 of FIG. 2D.

The example probability determination circuitry 106 determines (i) a compound probability that the population was not exposed to (e.g., did not tune to) the marketing campaign or the tuning was unmeasured across all days, dayparts, and stations, and (ii) a no-tuning probability corresponding to the probability that the population was not exposed to (e.g., did not tune to) the marketing campaign across all days, day parts, and stations (block 312). For example, the probability determination circuitry 106 determines the compound and no-tuning probabilities as shown in tables 11-14 of FIG. 2E.

The example additive reach determination circuitry 108 determines an additive reach adjustment based on the compound and no-tuning probabilities, the additive reach adjustment indicative of a probability (or percentage) that an entity was exposed to the marketing campaign but was not credited for the impressions (block 314). For example, the additive determination circuitry 108 determines the additive reach adjustment factor as shown in tables 15-16 of FIG. 2F.

FIG. 4 is a block diagram of an example processor platform 400 structured to execute and/or instantiate the machine readable instructions and/or the operations of FIG. 3 to implement the computing device 100 of FIG. 1. The processor platform 400 can be, for example, a server, a personal computer, a workstation, a self-learning machine (e.g., a neural network), a mobile device (e.g., a cell phone, a smart phone, a tablet such as an iPad™), an Internet appliance, or any other type of computing device.

The processor platform 400 of the illustrated example includes processor circuitry 412. The processor circuitry 412 of the illustrated example is hardware. For example, the processor circuitry 412 can be implemented by one or more integrated circuits, logic circuits, FPGAs, microprocessors, CPUs, GPUs, DSPs, and/or microcontrollers from any desired family or manufacturer. The processor circuitry 412 may be implemented by one or more semiconductor based (e.g., silicon based) devices. In this example, the processor circuitry 412 implements the example interface circuitry 102, the example tuning determination circuitry 104, the example probability determination circuitry 106, and the example additive reach determination circuitry 108.

The processor circuitry 412 of the illustrated example includes a local memory 413 (e.g., a cache, registers, etc.). The processor circuitry 412 of the illustrated example is in communication with a main memory including a volatile memory 414 and a non-volatile memory 416 by a bus 418. The volatile memory 414 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 416 may be implemented by flash memory and/or any other desired type of memory device. Access to the main memory 414, 416 of the illustrated example is controlled by a memory controller 417.

The processor platform 400 of the illustrated example also includes interface circuitry 420. The interface circuitry 420 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 422 are connected to the interface circuitry 420. The input device(s) 422 permit(s) a user to enter data and/or commands into the processor circuitry 412. The input device(s) 422 can be implemented by, for example, an audio sensor, a microphone, a camera (still or video), a keyboard, a button, a mouse, a touchscreen, a track-pad, a trackball, an isopoint device, and/or a voice recognition system.

One or more output devices 424 are also connected to the interface circuitry 420 of the illustrated example. The output device(s) 424 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, and/or a printer. The interface circuitry 420 of the illustrated example, thus, typically includes a graphics driver card, a graphics driver chip, and/or graphics processor circuitry such as a GPU.

The interface circuitry 420 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 426. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 400 of the illustrated example also includes one or more mass storage devices 428 to store software and/or data. Examples of such mass storage devices 428 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 432, which may be implemented by the machine readable instructions of FIG. 3, may be stored in the mass storage device 428, in the volatile memory 414, in the non-volatile memory 416, and/or on a removable non-transitory computer readable storage medium such as a CD or DVD.

FIG. 5 is a block diagram of an example implementation of the processor circuitry 412 of FIG. 4. In this example, the processor circuitry 412 of FIG. 4 is implemented by a microprocessor 500. For example, the microprocessor 500 may be a general purpose microprocessor (e.g., general purpose microprocessor circuitry). The microprocessor 500 executes some or all of the machine readable instructions of the flowchart of FIG. 3 to effectively instantiate the circuitry of FIG. 1 as logic circuits to perform the operations corresponding to those machine readable instructions. In some such examples, the circuitry of FIG. 1 is instantiated by the hardware circuits of the microprocessor 500 in combination with the instructions. For example, the microprocessor 500 may be implemented by multi-core hardware circuitry such as a CPU, a DSP, a GPU, an XPU, etc. Although it may include any number of example cores 502 (e.g., 1 core), the microprocessor 500 of this example is a multi-core semiconductor device including N cores. The cores 502 of the microprocessor 500 may operate independently or may cooperate to execute machine readable instructions. For example, machine code corresponding to a firmware program, an embedded software program, or a software program may be executed by one of the cores 502 or may be executed by multiple ones of the cores 502 at the same or different times. In some examples, the machine code corresponding to the firmware program, the embedded software program, or the software program is split into threads and executed in parallel by two or more of the cores 502. The software program may correspond to a portion or all of the machine readable instructions and/or operations represented by the flowchart of FIG. 3.

The cores 502 may communicate by a first example bus 504. In some examples, the first bus 504 may be implemented by a communication bus to effectuate communication associated with one(s) of the cores 502. For example, the first bus 504 may be implemented by at least one of an Inter-Integrated Circuit (I2C) bus, a Serial Peripheral Interface (SPI) bus, a PCI bus, or a PCIe bus. Additionally or alternatively, the first bus 504 may be implemented by any other type of computing or electrical bus. The cores 502 may obtain data, instructions, and/or signals from one or more external devices by example interface circuitry 506. The cores 502 may output data, instructions, and/or signals to the one or more external devices by the interface circuitry 506. Although the cores 502 of this example include example local memory 520 (e.g., Level 1 (L1) cache that may be split into an L1 data cache and an L1 instruction cache), the microprocessor 500 also includes example shared memory 510 that may be shared by the cores (e.g., Level 2 (L2 cache)) for high-speed access to data and/or instructions. Data and/or instructions may be transferred (e.g., shared) by writing to and/or reading from the shared memory 510. The local memory 520 of each of the cores 502 and the shared memory 510 may be part of a hierarchy of storage devices including multiple levels of cache memory and the main memory (e.g., the main memory 414, 416 of FIG. 4). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 502 may be referred to as a CPU, DSP, GPU, etc., or any other type of hardware circuitry. Each core 502 includes control unit circuitry 514, arithmetic and logic (AL) circuitry (sometimes referred to as an ALU) 516, a plurality of registers 518, the local memory 520, and a second example bus 522. Other structures may be present. For example, each core 502 may include vector unit circuitry, single instruction multiple data (SIMD) unit circuitry, load/store unit (LSU) circuitry, branch/jump unit circuitry, floating-point unit (FPU) circuitry, etc. The control unit circuitry 514 includes semiconductor-based circuits structured to control (e.g., coordinate) data movement within the corresponding core 502. The AL circuitry 516 includes semiconductor-based circuits structured to perform one or more mathematic and/or logic operations on the data within the corresponding core 502. The AL circuitry 516 of some examples performs integer based operations. In other examples, the AL circuitry 516 also performs floating point operations. In yet other examples, the AL circuitry 516 may include first AL circuitry that performs integer based operations and second AL circuitry that performs floating point operations. In some examples, the AL circuitry 516 may be referred to as an Arithmetic Logic Unit (ALU). The registers 518 are semiconductor-based structures to store data and/or instructions such as results of one or more of the operations performed by the AL circuitry 516 of the corresponding core 502. For example, the registers 518 may include vector register(s), SIMD register(s), general purpose register(s), flag register(s), segment register(s), machine specific register(s), instruction pointer register(s), control register(s), debug register(s), memory management register(s), machine check register(s), etc. The registers 518 may be arranged in a bank as shown in FIG. 5. Alternatively, the registers 518 may be organized in any other arrangement, format, or structure including distributed throughout the core 502 to shorten access time. The second bus 522 may be implemented by at least one of an I2C bus, a SPI bus, a PCI bus, or a PCIe bus

Each core 502 and/or, more generally, the microprocessor 500 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 500 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

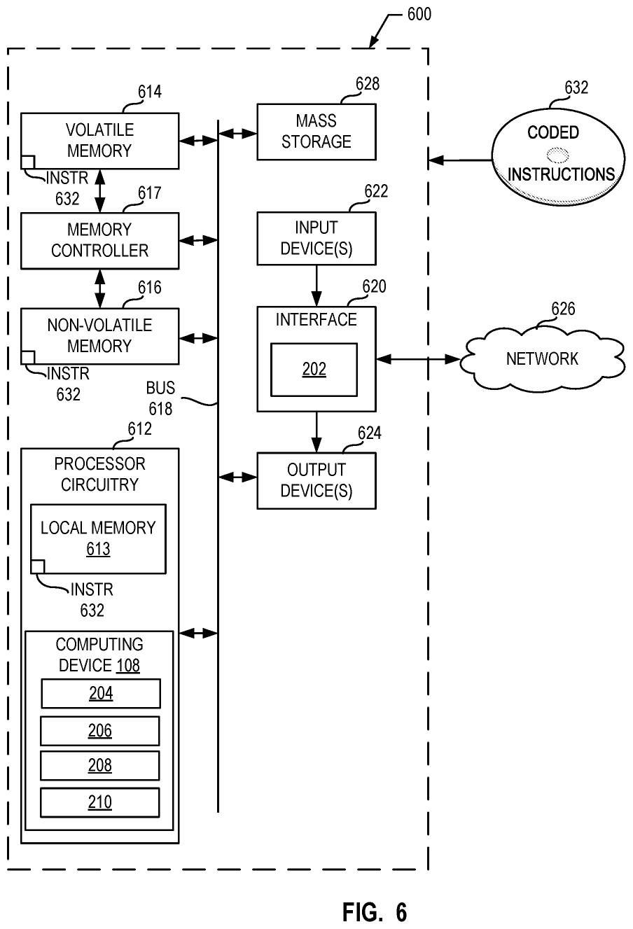

FIG. 6 is a block diagram of another example implementation of the processor circuitry 412 of FIG. 4. In this example, the processor circuitry 412 is implemented by FPGA circuitry 600. For example, the FPGA circuitry 600 may be implemented by an FPGA. The FPGA circuitry 600 can be used, for example, to perform operations that could otherwise be performed by the example microprocessor 500 of FIG. 5 executing corresponding machine readable instructions. However, once configured, the FPGA circuitry 600 instantiates the machine readable instructions in hardware and, thus, can often execute the operations faster than they could be performed by a general purpose microprocessor executing the corresponding software.

More specifically, in contrast to the microprocessor 500 of FIG. 5 described above (which is a general purpose device that may be programmed to execute some or all of the machine readable instructions represented by the flowchart of FIG. 3 but whose interconnections and logic circuitry are fixed once fabricated), the FPGA circuitry 600 of the example of FIG. 6 includes interconnections and logic circuitry that may be configured and/or interconnected in different ways after fabrication to instantiate, for example, some or all of the machine readable instructions represented by the flowchart of FIG. 3. In particular, the FPGA circuitry 600 may be thought of as an array of logic gates, interconnections, and switches. The switches can be programmed to change how the logic gates are interconnected by the interconnections, effectively forming one or more dedicated logic circuits (unless and until the FPGA circuitry 600 is reprogrammed). The configured logic circuits enable the logic gates to cooperate in different ways to perform different operations on data received by input circuitry. Those operations may correspond to some or all of the software represented by the flowchart of FIG. 3. As such, the FPGA circuitry 600 may be structured to effectively instantiate some or all of the machine readable instructions of the flowchart of FIG. 3 as dedicated logic circuits to perform the operations corresponding to those software instructions in a dedicated manner analogous to an ASIC. Therefore, the FPGA circuitry 600 may perform the operations corresponding to the some or all of the machine readable instructions of FIG. 3 faster than the general purpose microprocessor can execute the same.

In the example of FIG. 6, the FPGA circuitry 600 is structured to be programmed (and/or reprogrammed one or more times) by an end user by a hardware description language (HDL) such as Verilog. The FPGA circuitry 600 of FIG. 6, includes example input/output (I/O) circuitry 602 to obtain and/or output data to/from example configuration circuitry 604 and/or external hardware 606. For example, the configuration circuitry 604 may be implemented by interface circuitry that may obtain machine readable instructions to configure the FPGA circuitry 600, or portion(s) thereof. In some such examples, the configuration circuitry 604 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 606 may be implemented by external hardware circuitry. For example, the external hardware 606 may be implemented by the microprocessor 500 of FIG. 5. The FPGA circuitry 600 also includes an array of example logic gate circuitry 608, a plurality of example configurable interconnections 610, and example storage circuitry 612. The logic gate circuitry 608 and the configurable interconnections 610 are configurable to instantiate one or more operations that may correspond to at least some of the machine readable instructions of FIG. 3 and/or other desired operations. The logic gate circuitry 608 shown in FIG. 6 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 608 to enable configuration of the electrical structures and/or the logic gates to form circuits to perform desired operations. The logic gate circuitry 608 may include other electrical structures such as look-up tables (LUTs), registers (e.g., flip-flops or latches), multiplexers, etc.

The configurable interconnections 610 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 608 to program desired logic circuits.

The storage circuitry 612 of the illustrated example is structured to store result(s) of the one or more of the operations performed by corresponding logic gates. The storage circuitry 612 may be implemented by registers or the like. In the illustrated example, the storage circuitry 612 is distributed amongst the logic gate circuitry 608 to facilitate access and increase execution speed.

The example FPGA circuitry 600 of FIG. 6 also includes example Dedicated Operations Circuitry 614. In this example, the Dedicated Operations Circuitry 614 includes special purpose circuitry 616 that may be invoked to implement commonly used functions to avoid the need to program those functions in the field. Examples of such special purpose circuitry 616 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 600 may also include example general purpose programmable circuitry 618 such as an example CPU 620 and/or an example DSP 622. Other general purpose programmable circuitry 618 may additionally or alternatively be present such as a GPU, an XPU, etc., that can be programmed to perform other operations.

Although FIGS. 5 and 6 illustrate two example implementations of the processor circuitry 412 of FIG. 4, many other approaches are contemplated. For example, as mentioned above, modern FPGA circuitry may include an on-board CPU, such as one or more of the example CPU 620 of FIG. 6. Therefore, the processor circuitry 412 of FIG. 4 may additionally be implemented by combining the example microprocessor 500 of FIG. 5 and the example FPGA circuitry 600 of FIG. 6. In some such hybrid examples, a first portion of the machine readable instructions represented by the flowchart of FIG. 3 may be executed by one or more of the cores 502 of FIG. 5, a second portion of the machine readable instructions represented by the flowchart of FIG. 3 may be executed by the FPGA circuitry 600 of FIG. 6, and/or a third portion of the machine readable instructions represented by the flowchart of FIG. 3 may be executed by an ASIC. It should be understood that some or all of the circuitry of FIG. 2 may, thus, be instantiated at the same or different times. Some or all of the circuitry may be instantiated, for example, in one or more threads executing concurrently and/or in series. Moreover, in some examples, some or all of the circuitry of FIG. 2 may be implemented within one or more virtual machines and/or containers executing on the microprocessor.

In some examples, the processor circuitry 412 of FIG. 4 may be in one or more packages. For example, the microprocessor 500 of FIG. 5 and/or the FPGA circuitry 600 of FIG. 6 may be in one or more packages. In some examples, an XPU may be implemented by the processor circuitry 412 of FIG. 4, which may be in one or more packages. For example, the XPU may include a CPU in one package, a DSP in another package, a GPU in yet another package, and an FPGA in still yet another package.

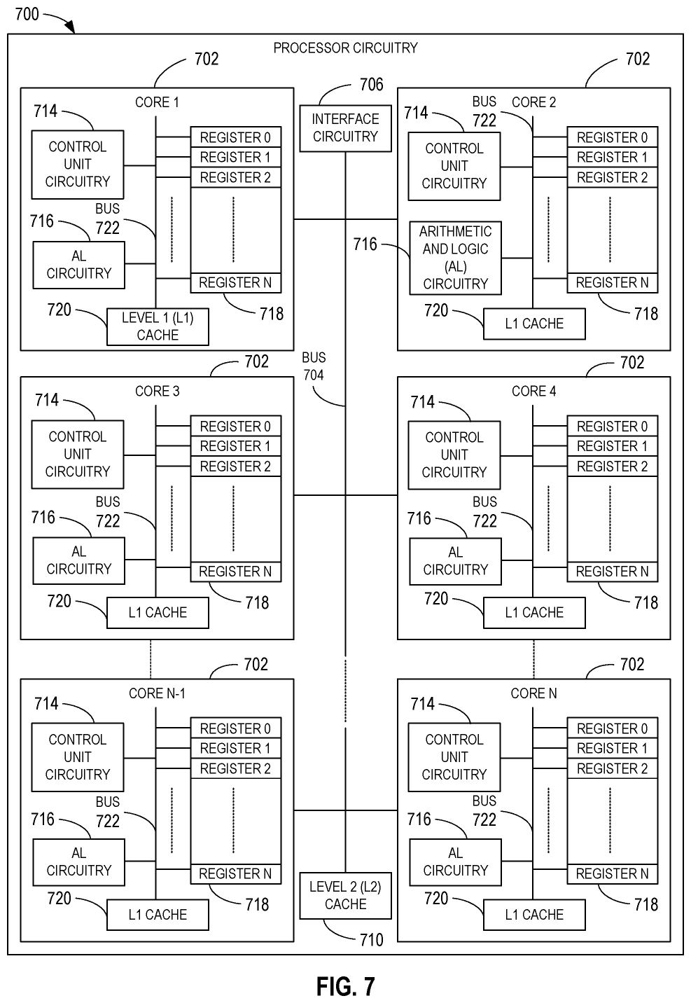

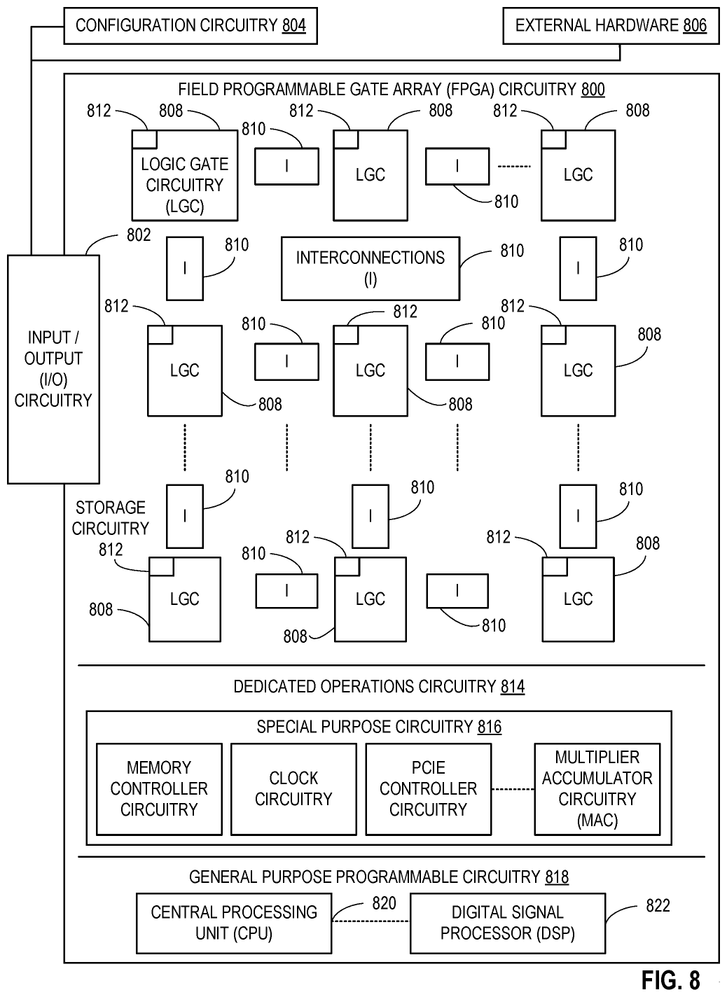

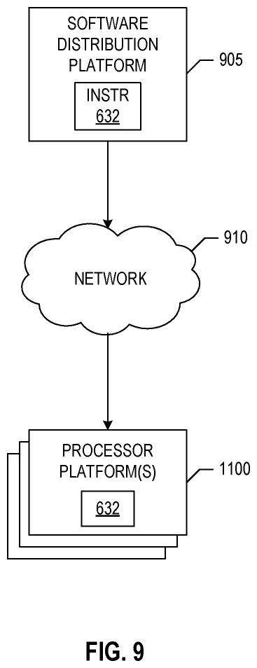

A block diagram illustrating an example software distribution platform 705 to distribute software such as the example machine readable instructions 432 of FIG. 4 to hardware devices owned and/or operated by third parties is illustrated in FIG. 7. The example software distribution platform 705 may be implemented by any computer server, data facility, cloud service, etc., capable of storing and transmitting software to other computing devices. The third parties may be customers of the entity owning and/or operating the software distribution platform 705. For example, the entity that owns and/or operates the software distribution platform 705 may be a developer, a seller, and/or a licensor of software such as the example machine readable instructions 432 of FIG. 4. The third parties may be consumers, users, retailers, OEMs, etc., who purchase and/or license the software for use and/or re-sale and/or sub-licensing. In the illustrated example, the software distribution platform 705 includes one or more servers and one or more storage devices. The storage devices store the machine readable instructions 432, which may correspond to the example machine readable instructions 300 of FIG. 3, as described above. The one or more servers of the example software distribution platform 705 are in communication with an example network 710, which may correspond to any one or more of the Internet and/or any of the example networks 426 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 432 from the software distribution platform 705. For example, the software, which may correspond to the example machine readable instructions 300 of FIG. 3, may be downloaded to the example processor platform 400, which is to execute the machine readable instructions 432 to implement the computing device 100. In some examples, one or more servers of the software distribution platform 705 periodically offer, transmit, and/or force updates to the software (e.g., the example machine readable instructions 432 of FIG. 4) to ensure improvements, patches, updates, etc., are distributed and applied to the software at the end user devices.

Further implementation details concerning example technical solutions to determine additive reach adjustment factors for audience measurement in accordance with teachings of this disclosure are provided in Appendices 1, 2 and 3.

From the foregoing, it will be appreciated that example systems, methods, apparatus, and articles of manufacture have been disclosed that determine an additive reach adjustment factor to facilitate accurately estimating reach on-demand (e.g., in real-time). Disclosed systems, methods, apparatus, and articles of manufacture improve the efficiency of using a computing device by reducing computation cycles that would be required for re-calculating reach when station factors do not accurately represent a true reach. Disclosed systems, methods, apparatus, and articles of manufacture are accordingly directed to one or more improvement(s) in the operation of a machine such as a computer or other electronic and/or mechanical device.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1. A computing system comprising a processor and a memory, the computing system configured to perform a set of acts comprising:
obtaining respective station tuning factors for multiple stations, each station tuning factor of the respective tuning factors derived from panel data and indicative of a weight added to tuning data to account for missing tuning data that is unmeasured by automatic content recognition (ACR) devices due to unidentified content;
obtaining panel data from panelist households, wherein the panelist households have respective weights indicative of how many people in a population are represented by the panelist household;
determining, using the station tuning factors and the panel data, a percentage of a target population for which all tuning to a media campaign on the multiple stations was missed during a time period by the ACR devices;
determining an initial reach for the media campaign on the multiple stations during the time period using tuning data obtained via the ACR devices;
determining a revised reach for the media campaign on the multiple stations during the time period using the initial reach and the percentage of the target population, thereby accounting for an error in the initial reach due to the missing tuning data; and
outputting the revised reach.

2. The computing system of claim 1, wherein determining the revised reach comprises using the percentage of the target population as an additive adjustment factor.

3. The computing system of claim 2, wherein using the percentage of the target population as the additive adjustment factor comprises adding the percentage of the target population to the initial reach.

4. The computing system of claim 1, wherein determining the percentage of the target population comprises determining the percentage of the target population based on: a probability of not tuning or tuning and missing for the multiple stations, and a probability of not tuning for the multiple stations.

5. The computing system of claim 4, wherein the set of acts further comprises determining:
the probability of not tuning or tuning and missing for the multiple stations; and
the probability of not tuning for the multiple stations.

6. The computing system of claim 1, wherein the panel data comprises, for respective panelist households of the panelist households, meter data identifying which member of the panelist household is using a media presentation device at a given time and the station the media presentation device is tuned to at the given time.

7. The computing system of claim 6, wherein the meter data for the panelist households is obtained using respective panel meters.

8. A method comprising:
obtaining respective station tuning factors for multiple stations, each station tuning factor of the respective tuning factors derived from panel data and indicative of a weight added to tuning data to account for missing tuning data that is unmeasured by automatic content recognition (ACR) devices due to unidentified content;
obtaining panel data from panelist households, wherein the panelist households have respective weights indicative of how many people in a population are represented by the panelist household;
determining, using the station tuning factors and the panel data, a percentage of a target population for which all tuning to a media campaign on the multiple stations was missed during a time period by the ACR devices;
determining an initial reach for the media campaign on the multiple stations during the time period using tuning data obtained via the ACR devices;
determining a revised reach for the media campaign on the multiple stations during the time period using the initial reach and the percentage of the target population, thereby accounting for an error in the initial reach due to the missing tuning data; and
outputting the revised reach.

9. The method of claim 8, wherein determining the revised reach comprises using the percentage of the target population as an additive adjustment factor.

10. The method of claim 9, wherein using the percentage of the target population as the additive adjustment factor comprises adding the percentage of the target population to the initial reach.

11. The method of claim 8, wherein determining the percentage of the target population comprises determining the percentage of the target population based on: a probability of not tuning or tuning and missing for the multiple stations, and a probability of not tuning for the multiple stations.

12. The method of claim 11, further comprising determining:
the probability of not tuning or tuning and missing for the multiple stations; and
the probability of not tuning for the multiple stations.

13. The method of claim 8, wherein the panel data comprises, for respective panelist households of the panelist households, meter data identifying which member of the panelist household is using a media presentation device at a given time and the station the media presentation device is tuned to at the given time.

14. The method of claim 13, wherein the meter data for the panelist households is obtained using respective panel meters.

15. A non-transitory computer-readable medium having stored therein instructions that when executed by a computing system cause the computing system to perform a set of acts comprising:
obtaining respective station tuning factors for multiple stations, each station tuning factor of the respective tuning factors derived from panel data and indicative of a weight added to tuning data to account for missing tuning data that is unmeasured by automatic content recognition (ACR) devices due to unidentified content;
obtaining panel data from panelist households, wherein the panelist households have respective weights indicative of how many people in a population are represented by the panelist household;
determining, using the station tuning factors and the panel data, a percentage of a target population for which all tuning to a media campaign on the multiple stations was missed during a time period by the ACR devices;
determining an initial reach for the media campaign on the multiple stations during the time period using tuning data obtained via the ACR devices;
determining a revised reach for the media campaign on the multiple stations during the time period using the initial reach and the percentage of the target population, thereby accounting for an error in the initial reach due to the missing tuning data; and
outputting the revised reach.

16. The non-transitory computer-readable medium of claim 15, wherein determining the revised reach comprises using the percentage of the target population as an additive adjustment factor.

17. The non-transitory computer-readable medium of claim 16, wherein using the percentage of the target population as the additive adjustment factor comprises adding the percentage of the target population to the initial reach.

18. The non-transitory computer-readable medium of claim 15, wherein determining the percentage of the target population comprises determining the percentage of the target population based on: a probability of not tuning or tuning and missing for the multiple stations, and a probability of not tuning for the multiple stations.

19. The non-transitory computer-readable medium of claim 18, wherein the set of acts further comprises determining:
the probability of not tuning or tuning and missing for the multiple stations; and
the probability of not tuning for the multiple stations.

20. The non-transitory computer-readable medium of claim 15, wherein the panel data comprises, for respective panelist households of the panelist households, meter data identifying which member of the panelist household is using a media presentation device at a given time and the station the media presentation device is tuned to at the given time.
